(19) United States
(12) Patent Application Publication
(10) Pub. No.: US 2021/0374752 A1
(43) Pub. Date: Dec. 2, 2021

(54) INFORMATION PROCESSING SYSTEM, SERVER, AND COMPUTER READABLE RECORDING MEDIUM

(71) Applicant: TOYOTA JIDOSHA KABUSHIKI KAISHA, Toyota--shi (JP)

(72) Inventors: Shintaro MATSUTANI, Kariya-shi (JP); Misato YOKOTA, Tokyo-to (JP); Yumiko OSAKI, Tokyo-to (JP); Atsushi YONEKI, Chigasaki-shi (JP); Kazunari TSUTSUMI, Tokyo-to (JP); Mitsunori ISODA, Tokyo-to (JP); Yuzo YAMADA, Nagoya-shi (JP)

(73) Assignee: TOYOTA JIDOSHA KABUSHIKI KAISHA, Toyota-shi (JP)

(21) Appl. No.: 17/240,023

(22) Filed: Apr. 26, 2021

(30) Foreign Application Priority Data
May 29, 2020 (JP) 2020-094438

(51) Int. Cl. G06Q 20/40; G06Q 20/36; G06Q 20/06; G06Q 20/32

(52) U.S. Cl. CPC G06Q 20/4015; G06Q 20/3224; G06Q 20/065; G06Q 20/36

(57) ABSTRACT

An information processing system includes: a first mobile terminal including a first processor including hardware; and a server including a second processor including hardware, wherein the first processor is configured to output, to the server, attendance information indicating that a user attends an event requiring a participation fee, and a settlement request for the participation fee using electronic money deposited into an electronic wallet, and the second processor is configured to decide the user as an attendee of the event, and perform settlement processing of the participation fee by the electronic money based on the attendance information and the settlement request.

The present application claims priority to and incorporates by reference the entire contents of Japanese Patent Application No. 2020-094438 filed in Japan on May 29, 2020.

### BACKGROUND

The present disclosure relates to an information processing system, a server, and a computer readable recording medium.

JP 2011-232854 A discloses a technique for reducing time and effort caused by exchange of money such as admission fees at a venue of an event such as an exhibition.

### SUMMARY

For example, in an event such as a wedding ceremony or its after-party, it is troublesome for an organizer of the event to confirm attendance of prospective participants and to collect participation fees for the event.

There is a need for an information processing system, a server, and a computer readable recording medium that facilitate confirmation of attendance of prospective participants and collection of money for an organizer of an event.

According to one aspect of the present disclosure, there is provided an information processing system including: a first mobile terminal including a first processor including hardware; and a server including a second processor including hardware, wherein the first processor is configured to output, to the server, attendance information indicating that a user attends an event requiring a participation fee, and a settlement request for the participation fee using electronic money deposited into an electronic wallet, and the second processor is configured to decide the user as an attendee of the event, and perform settlement processing of the participation fee by the electronic money based on the attendance information and the settlement request.

### BRIEF DESCRIPTION OF THE DRAWINGS

FIG. 1 is a schematic diagram illustrating a schematic configuration of an information processing system according to an embodiment;

FIG. 2 is a block diagram illustrating functional blocks of the information processing system according to the embodiment;

FIG. 3 is a sequence diagram illustrating a control flow at the time of attendance processing;

FIG. 4 is a sequence diagram illustrating a control flow at the time of return processing; and

FIG. 5 is a sequence diagram illustrating a control flow at the time of using points.

### DETAILED DESCRIPTION

Hereinafter, an information processing system, a server, and a computer readable recording medium storing a program according to an embodiment will be specifically described with reference to the drawings. Note that the present disclosure is not limited to the embodiment described below.

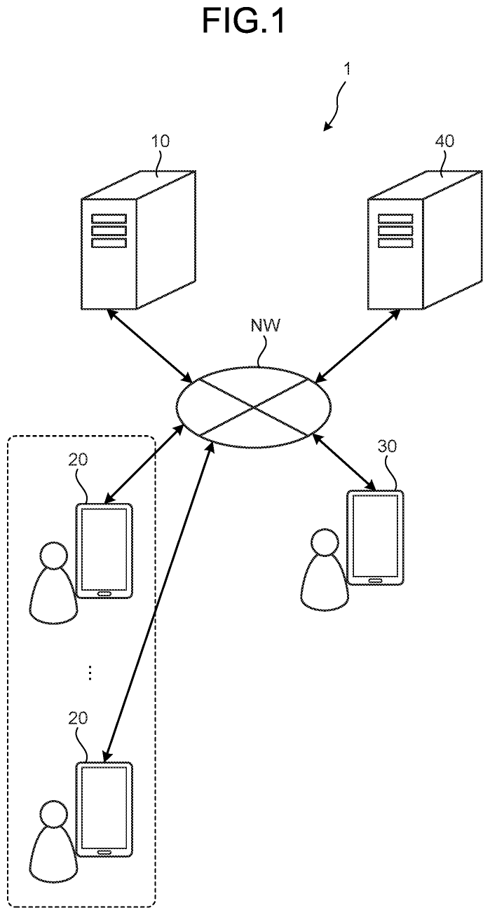

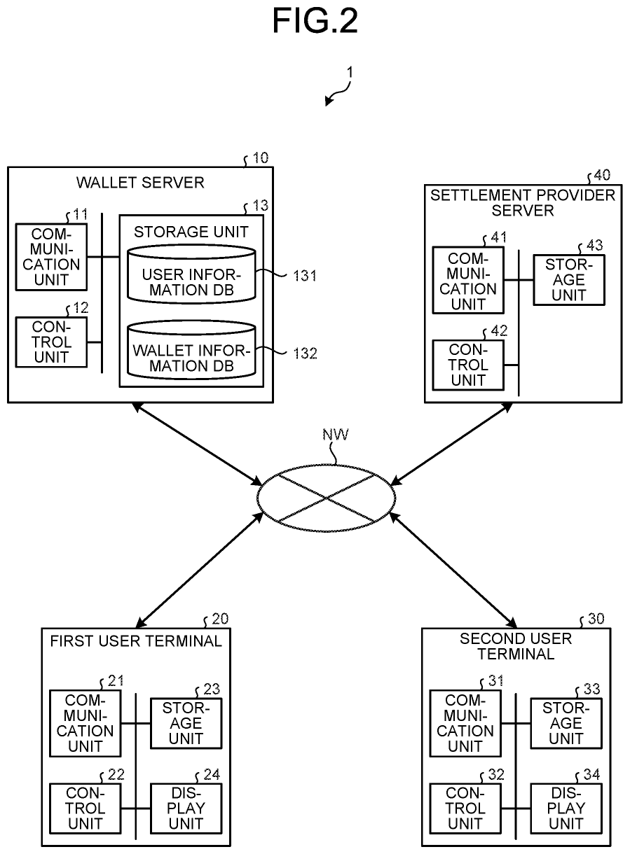

A configuration of the information processing system according to the embodiment will be described with reference to FIGS. 1 and 2. As illustrated in FIG. 1, an information processing system 1 of the embodiment includes a wallet server 10, first user terminals 20, a second user terminal 30, and a settlement provider server 40.

In the information processing system 1, the wallet server 10, the first user terminals 20, the second user terminal 30, and the settlement provider server 40 may communicate with each other through a network NW. The network NW includes, for example, an Internet line network and a mobile phone line network.

The wallet server 10 is a server for comprehensively managing a wallet system, and is managed by an administrator of the wallet system. As illustrated in FIG. 2, the wallet server 10 includes a communication unit 11, a control unit 12, and a storage unit 13.

The communication unit 11 includes, for example, a local area network (LAN) interface board and a wireless communication circuit for wireless communication. The communication unit 11 is connected to the network NW such as the Internet serving as a public communication network. In addition, the communication unit 11 communicates with the first user terminals 20, the second user terminal 30, and the settlement provider server 40 by connecting to the network NW.

The control unit 12 includes a processor and a memory. The processor includes a central processing unit (CPU), a digital signal processor (DSP), and a field-programmable gate array (FPGA). The memory is a main storage device, and includes a random access memory (RAM) and a read only memory (ROM). The control unit 12 loads a program stored in the storage unit 13 into a work area of the memory (main storage device), executes the program, and controls each component and the like through the execution of the program, thereby implementing a function matching a predetermined purpose.

The storage unit 13 includes a recording medium such as an erasable programmable ROM (EPROM), a hard disk drive (HDD), and a removable medium. Examples of the removable medium include a universal serial bus (USB) memory and a disc recording medium such as a compact disc (CD), a digital versatile disc (DVD), and a Blu-ray (registered trademark) disc (BD). The storage unit 13 may store an operating system (OS), various programs, various tables, various databases (DBs), and the like. The storage unit 13 includes a user information database 131 and a wallet information database 132.

The user information database 131 stores information regarding a user who uses the information processing system (hereinafter, referred to as “user information”). Examples of the user information include a user ID of the user who has registered to use the wallet system, a password, a name of the user, contact information (for example, address, phone number, and email address) of the user, a use registration history, information regarding a payment method registered as a depositing method, information regarding a payment method registered as a settlement method, a personal identification number at the time of settlement, classification, presence or absence of an approver, and presence or absence of a use restriction. Note that, in the user information, the user ID and the password are used for authentication processing such as login to the wallet server 10.

The wallet information database 132 stores information regarding an electronic wallet of the information processing system 1 (hereinafter, referred to as “wallet information”). Examples of the wallet information include a user ID, a balance of electronic money, a deposit history of electronic money, and a use history of electronic money. In addition, the wallet information database 132 stores information regarding settlement of the wallet system (hereinafter, referred to as “settlement information”). Examples of the settlement information include a user ID, a settlement method used for settlement (for example, electronic money payment, scan payment, and code payment), and a settlement history. Note that electronic money payment is contactless settlement.

In addition, the storage unit 13 stores wedding ceremony information, invitation information, attendance confirmation information, attendance information, depositing request information, information regarding progress of a money collection status, information regarding attendees, amount information of gift money, catalog information, information regarding return gifts, information regarding the number of points required for exchange, and the like. Note that event information such as wedding ceremony information may be stored in a server different from the wallet server 10. In short, it is sufficient that the wallet server 10 is configured to be capable of acquiring event information.

The first user terminal 20 is a computer terminal used by an attendee or an invited guest who is a first user. Examples of the first user terminal 20 include a smartphone, a mobile phone, a tablet terminal, a wearable computer, and a personal computer, which are used by the user. The information processing system 1 includes a plurality of first user terminals 20 because there is a plurality of participants in an event, there is a plurality of guests invited to a wedding ceremony, or for other reasons.

The first user terminal 20 includes a communication unit 21, a control unit 22, a storage unit 23, and a display unit 24. The communication unit 21, the control unit 22, and the storage unit 23 included in the first user terminal 20 are physically similar to the communication unit 11, the control unit 12, and the storage unit 13 included in the wallet server 10. The first user terminal 20 may be any terminal as long as it is a mobile terminal capable of transmitting and receiving information to and from the wallet server 10 via the network NW.

The control unit 22 functions as a display control unit, a depositing method registration unit, a settlement method registration unit, a depositing processing unit, and a settlement processing unit through execution of a program stored in the storage unit 23.

When functioning as the display control unit, the control unit 22 controls display contents on the display unit 24. Based on operation of a user (touch operation, flick operation, and the like), the control unit 22 displays various screens on the display unit 24. Examples of the screens to be displayed include a login screen for logging in to the wallet system, a settlement screen for performing settlement by scan payment or the like, a use history screen showing a list of use histories of settlement and the like, a payment history detail screen showing details of a payment history, and a depositing screen for depositing electronic money into the electronic wallet. Furthermore, the control unit 22 performs transition of each screen based on operation of a user.

In addition, when functioning as the depositing method registration unit, the control unit 22 registers a depositing method for depositing electronic money. The depositing method refers to a method for depositing electronic money into the electronic wallet serving as a virtual deposit/withdrawal account. Examples of the depositing method include a bank account and a credit card among payment methods. By registration of the bank account and the credit card as the depositing methods, it becomes possible to deposit electronic money into the electronic wallet. In addition, the payment method refers to a method that serves as funds for payment when settlement is performed. Examples of the payment method include a bank account, a credit card, and a balance of electronic money in the electronic wallet. A bank account is associated with each credit card, and a use amount of each card is withdrawn from the bank account at a later date.

The control unit 22 transmits, to the wallet server 10, a depositing method registration request for registering a plurality of different payment methods operated by a plurality of companies as depositing methods to the electronic wallet. When receiving the depositing method registration request from the first user terminal 20, the control unit 12 of the wallet server 10 stores, in the user information database 131 of the storage unit 13, the payment methods included in the depositing method registration request as the user information. Thus, the payment methods are registered as the depositing methods in the user information database 131.

In addition, when functioning as the settlement method registration unit, the control unit 22 registers the payment method to be registered as the depositing method also as a settlement method. The settlement method refers to a method of performing settlement by using the payment method. Examples of the settlement method include scan payment, electronic money payment, and code payment. The scan payment, the electronic money payment, and the code payment are all settlement methods using a balance of electronic money in the electronic wallet.

For example, the control unit 22 transmits, to the wallet server 10 or a store terminal, a settlement request for performing settlement by electronic money deposited into the electronic wallet by using one of a plurality of settlement methods (electronic money payment, scan payment, and code payment) set in advance. At this time, when the electronic money payment is performed, the control unit 22 transmits a payment request to the store terminal through a short-range wireless communication unit. In addition, the scan payment is settlement performed by reading a barcode or QR code (registered trademark) posted in a store with a camera or the like of the first user terminal 20. In addition, when the code payment is performed, the control unit 22 transmits a payment request to the store terminal by causing a reading unit such as a code reader of the store terminal to read a barcode or QR code (registered trademark) displayed on the first user terminal 20. Note that, in the scan payment, a barcode or QR code (registered trademark) displayed on the store terminal such as a cash register may be read by the first user terminal 20.

In addition, when functioning as the depositing processing unit, the control unit 22 deposits electronic money into the electronic wallet. The control unit 22 transmits, to the wallet server 10, a depositing request for depositing electronic money into the electronic wallet by the payment method registered as the depositing method. When receiving the depositing request from the first user terminal 20, the control unit 12 of the wallet server 10 increases a balance of electronic money in the electronic wallet based on deposit amount information included in the depositing request. That is, the control unit 12 updates the wallet information stored in the storage unit 13 according to the increase in the balance of electronic money in the electronic wallet.

In addition, when functioning as the settlement processing unit, the control unit 22 performs settlement by the payment method. For example, when scan payment is performed, the control unit 22 transmits a payment request (settlement request) to the wallet server 10 by reading a QR code (registered trademark) posted in a store with the camera or the like of the first user terminal 20.

Note that, when functioning as the settlement processing unit, the control unit 22 may also perform settlement by the payment method other than a balance of electronic money in the electronic wallet (for example, a bank account or a credit card). For example, when the depositing method registration request is transmitted from the first user terminal 20 to the wallet server 10, the control unit 22 transmits, to the wallet server 10, a registration request for registering the payment method included in the depositing method registration request as the settlement method. That is, when registering a certain payment method (for example, a bank account of X bank) as the depositing method in the wallet server 10, the control unit 22 automatically registers the payment method (bank account of X bank) also as the settlement method. “Registering the payment method as the settlement method” means making it possible to perform settlement by using the payment method as a payment source. That is, it means that scan payment is made possible by using the bank account of the X bank as the payment source. When receiving the registration request from the first user terminal 20, the control unit 12 of the wallet server 10 stores, as the user information, the payment method included in the registration request in the user information database 131. Thus, the payment method is registered as the settlement method. Then, the control unit 22 transmits, to the wallet server 10, a payment request for making payment by a bank account or a credit card by using one of the plurality of settlement methods. When receiving the payment request (settlement request) from the first user terminal 20, the control unit 12 transmits settlement amount information included in the payment request to the settlement provider server 40. Then, settlement processing is performed by information communication between the wallet server 10 and the settlement provider server 40.

The storage unit 23 stores data of various screens to be displayed by the control unit 22 on the display unit 24. In addition, the storage unit 23 temporarily stores the user information, the wallet information, and the like, as needed.

The display unit 24 includes a touch panel display, for example, and has an input function for accepting operation by a finger of the user, a pen, or the like, and a display function for displaying various types of information under the control of the control unit 22.

The second user terminal 30 is a computer terminal used by an organizer who is a second user. Examples of the second user terminal 30 include a smartphone, a mobile phone, a tablet terminal, a wearable computer, and a personal computer, which are used by the second user.

The second user terminal 30 includes a communication unit 31, a control unit 32, a storage unit 33, and a display unit 34. The communication unit 31, the control unit 32, the storage unit 33, and the display unit 34 included in the second user terminal 30 are physically similar to the communication unit 21, the control unit 22, the storage unit 23, and the display unit 24 included in the first user terminal 20. The second user terminal 30 may be any terminal as long as it is a mobile terminal capable of transmitting and receiving information to and from the wallet server 10 via the network NW.

The settlement provider server 40 is a server for managing an account and a credit card of a user, and is provided in financial institutions (for example, banks, credit unions, credit associations, and labor banks) and credit card companies. The settlement provider server 40 includes a communication unit 41, a control unit 42, and a storage unit 43. The communication unit 41, the control unit 42, and the storage unit 43 included in the settlement provider server 40 are physically similar to the communication unit 11, the control unit 12, and the storage unit 13 included in the wallet server 10.

The storage unit 43 stores account information and credit card information, for each user of the wallet system. Examples of the account information include a name of the user, an account number, an account balance, and a deposit/withdrawal history. Examples of the credit card information include a name of the user, a credit card number, an expiration date of the credit card, use limit amount, and a card use history.

In the information processing system 1 configured as described above, an organizer of an event or the like may grasp a plurality of participants in advance, and collect a participation fee for the event in advance by using an electronic wallet associated with each user. Examples of the event include a meeting that requires a participation fee and seats for a plurality of participants, and a wedding ceremony that requires delivery of gift money or confirmation of attendance of a plurality of invited guests.

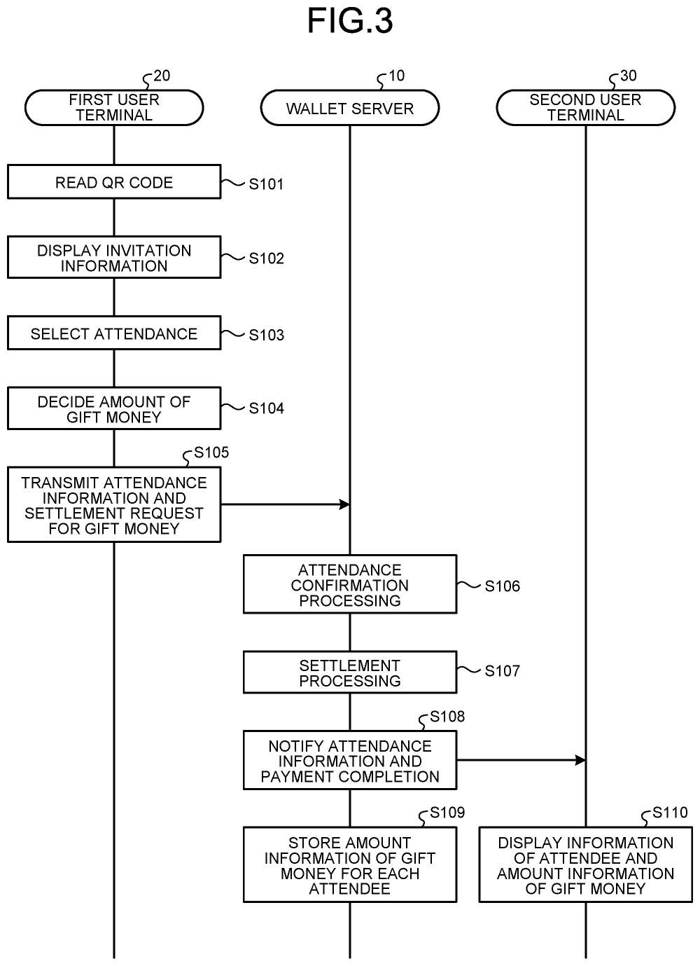

FIG. 3 is a sequence diagram illustrating a control flow at the time of attendance processing. Note that FIG. 3 illustrates a control flow using a wedding ceremony as an example.

The first user terminal 20 reads a QR code (registered trademark) posted on an invitation (Step S101) and displays invitation information corresponding to the QR code (registered trademark) on the display unit 24 (Step S102). In step S101, the QR code (registered trademark) including the invitation information to the wedding ceremony is read by the reading unit of the first user terminal 20. In Step S102, as the invitation information, attendance confirmation information for confirming attendance or absence to the wedding ceremony and input request information for deciding an amount of gift money when attending the wedding ceremony are displayed on the display unit 24 of the first user terminal 20. The first user terminal 20 displays the attendance confirmation information and the input request information as images operable by a first user.

The first user terminal 20 detects, as operation by the first user, operation of selecting attendance at the invited wedding ceremony (Step S103). In Step S103, it is detected that a display button for selecting attendance at the wedding ceremony is selected for the attendance confirmation information displayed on the display unit 24.

In addition, the first user terminal 20 decides an amount of gift money according to operation by the first user (Step S104). In Step S104, user operation indicating that a decision button for deciding the amount of gift money in a state where the amount of gift money is input is selected is detected for the input request information displayed on the display unit 24. Note that, in Step S104, user operation indicating that gift money has been decided in a state of being selected from a plurality of options, as in a pull-down system, may be detected.

Then, when the user operation to the attendance confirmation information and the input request information for the invitation information is completed, the first user terminal 20 transmits, to the wallet server 10, attendance information and a settlement request for gift money corresponding to the invitation information (Step S105). In Step S105, as the settlement request for gift money, a settlement request using an electronic wallet associated with the first user is made.

When receiving the attendance information and the settlement request for gift money corresponding to the invitation information of the wedding ceremony, the wallet server 10 performs attendance confirmation processing for deciding the user as a prospective participant (Step S106). In Step S106, based on identification information included in the attendance information, it is specified which wedding ceremony the attendance information is for. In addition, the wallet server 10 may count the total number of persons scheduled to attend the wedding ceremony according to the attendance information.

Furthermore, based on the settlement request for gift money, the wallet server 10 performs settlement processing using the electronic wallet associated with the first user (Step S107). In Step S107, first, wallet information associated with the first user is specified by referring to the storage unit 13 based on user identification information included in the attendance information. For example, when the received settlement request for gift money is a settlement request designating one of a plurality of settlement methods registered in the electronic wallet, the wallet server 10 performs settlement using the designated settlement method. When performing the settlement processing of gift money using the electronic wallet, the wallet server 10 performs information communication with the settlement provider server 40 associated with the electronic wallet and performs the settlement processing.

When the attendance confirmation processing and the settlement processing of gift money are completed, the wallet server 10 transmits, to the second user terminal 30, a notification indicating the attendance information regarding the first user and completion of payment of the gift money by electronic settlement (Step S108). In Step S108, a completion notification indicating completion of information processing of the participant is transmitted to an organizer terminal registered as an organizer of the wedding ceremony.

In addition, the wallet server 10 stores amount information of gift money for each attendee in the storage unit 13 (Step S109). In Step S109, among invited guests, a user who has answered to attend and a user who has answered to be absent are stored in the storage unit 13, and an amount of gift money paid by the attending user is stored in the storage unit 13 as the amount information.

When receiving the notification of the attendance information and the payment completion from the wallet server 10, the second user terminal 30 displays the information of the attendee and the amount information of gift money on the display unit 34 (Step S110). In Step S110, the storage unit 33 of the second user terminal 30 temporarily stores the information of the attendee and the amount information of gift money.

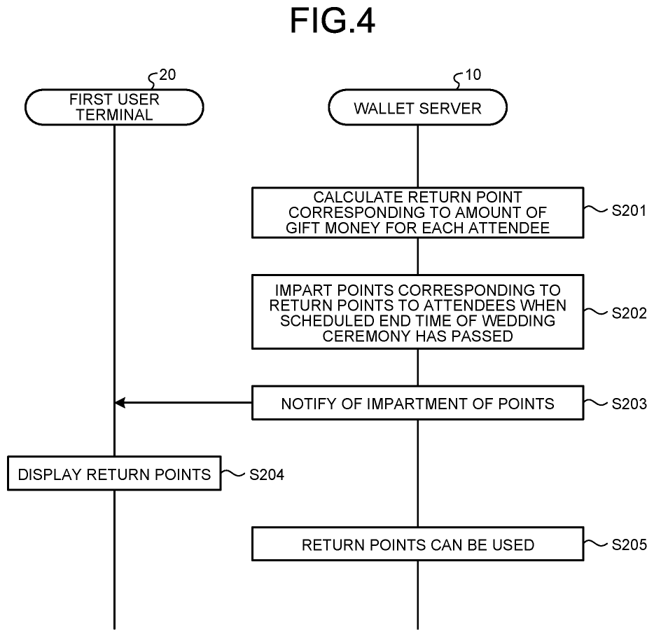

FIG. 4 is a sequence diagram illustrating a control flow at the time of return processing.

The wallet server 10 calculates return points corresponding to an amount of gift money for each attendee for users who has answered to attend among the invited guests (Step S201). In Step S201, return points are calculated for each attendee by using a ratio of the return points to the amount of gift money. The ratio used in Step S201 is a preset value. In addition, the ratio may be set by any method, for example, the ratio may be set to vary according to the amount of gift money, or the ratio may be set to be the same regardless of the amount of gift money. Note that, in Step S201, return points may be calculated at the timing of executing the processing in Step S106 in FIG. 3.

When scheduled end time of the wedding ceremony has passed, the wallet server 10 imparts return points to the attendees (Step S202). The scheduled end time of the wedding ceremony has been registered as the wedding ceremony information, and in Step S202, based on the wedding ceremony information, the wallet server 10 may determine that the scheduled end time of the wedding ceremony has passed. In addition, the return points are imparted to an electronic wallet associated with each attendee. That is, the wallet server 10 imparts the return points calculated in Step S201 to the electronic wallet used for the settlement processing of gift money for each attendee.

When impartment of the return points to the attendees is completed, the wallet server 10 notifies the first user terminal 20 of information indicating impartment of the return points (Step S203). In Step S203, a notification is transmitted to the corresponding first user terminal 20 for each attendee.

Then, when receiving the notification indicating completion of impartment of the return points, the first user terminal 20 displays information regarding the return points on the display unit 24 (Step S204). In Step S204, the number of return points imparted to the electronic wallet of the first user is displayed on a screen.

In addition, when the notification of impartment of the return points to all the attendees is completed, the wallet server 10 executes release processing for enabling use of the return points (Step S205). In Step S205, for example, restriction is released so that the return points which has been restricted to be unusable at the time of calculation in Step S201 becomes usable at the time of notification in Step S203.

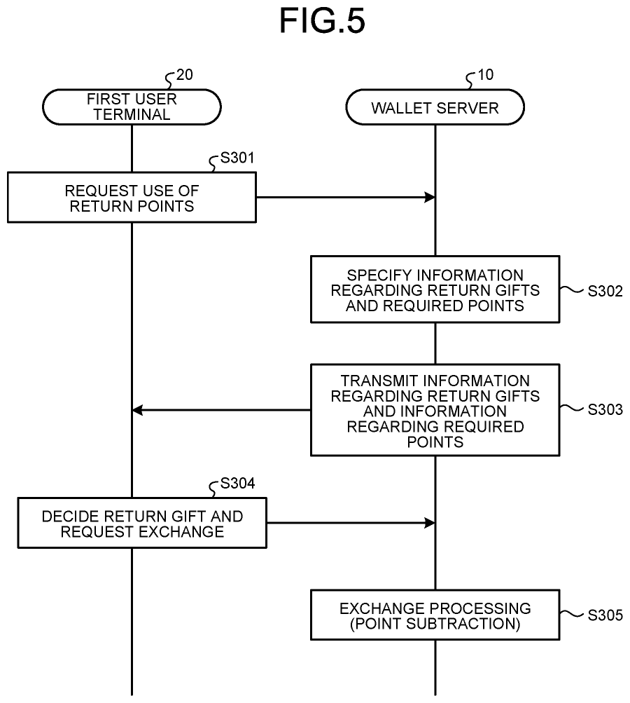

FIG. 5 is a sequence diagram illustrating a control flow at the time of using points.

The first user terminal 20 transmits a use request of return points to the wallet server 10 (Step S301). In Step S301, a request for information regarding return gifts exchangeable for the return points is transmitted to the wallet server 10.

Based on the use request of the return points, the wallet server 10 specifies the information regarding the return gifts and information regarding the number of points required to exchange for the return gifts (Step S302). In Step S302, catalog information to be the object of the return gifts is specified.

The wallet server 10 transmits, to the first user terminal 20, the information regarding the return gifts and the information regarding the required number of points (Step S303).

When receiving the information regarding the return gifts, the first user terminal 20 displays the information on the display unit 24. Then, when detecting user operation from the first user for deciding a return gift, the first user terminal 20 transmits, to the wallet server 10, an exchange request for exchanging the return gift and the return points (Step S304). In Step S304, the exchange request may be a request for exchanging by consuming all of the return points or a request for exchanging by consuming a part of the return points.

Then, the wallet server 10 performs exchange processing for exchanging the return points and the return gift based on the exchange request from the first user terminal 20 (Step S305). In Step S305, the number of points required to exchange for the return gift is subtracted from the return points.

As described above, according to the embodiment, the organizer of the wedding ceremony may easily confirm attendance of the prospective participants and collect gift money. This eliminates the need to collect gift money on the wedding day.

In addition, as a modification of the embodiment, it is possible to impart points for a car fare to an invited guest who came from a distant place among invited guests who attended the wedding ceremony. In this case, when the participant settles transportation expenses by using an electronic wallet, the wallet server 10 imparts points corresponding to the transportation expenses to the electronic wallet as the car fare. This makes it possible to settle an actual cost of the car fare. At that time, in the electronic wallet, gift money paid by the participant may be offset by the car fare corresponding to actual transportation expenses. Note that an upper limit is set for the car fare, and if the actual transportation expenses exceed the upper limit, points corresponding to the upper limit are imparted to the electronic wallet.

According to the present disclosure, it becomes easy for an organizer of an event to confirm attendance of prospective participants and collect money from the prospective participants.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing system comprising:
a first mobile terminal comprising a first processor comprising hardware; and
a server comprising a second processor comprising hardware,
wherein the first processor is configured to output, to the server, attendance information indicating that a user attends an event requiring a participation fee, and a settlement request for the participation fee using electronic money deposited into an electronic wallet, and
the second processor is configured to
decide the user as an attendee of the event, and
perform settlement processing of the participation fee by the electronic money based on the attendance information and the settlement request.

2. The information processing system according to claim 1, further comprising
a second mobile terminal comprising
a third processor comprising hardware, and
a first display,
wherein, the second processor is configured to output, to the second mobile terminal, a completion notification indicating completion of attendance confirmation of the user to the event and payment of the participation fee after the settlement processing is completed.

3. The information processing system according to claim 2, wherein the third processor is configured to displays, on the first display, information regarding the attendee and information indicating completion of payment of the participation fee in response to the completion notification.

4. The information processing system according to claim 2, wherein
the attendee is one of a plurality of invited guests invited by an organizer of a wedding ceremony,
the first mobile terminal is an invited guest terminal used by each invited guest,
the second mobile terminal is an organizer terminal used by the organizer,
the first processor is configured to output, in a case where an amount of gift money as the participation fee is decided, a settlement request for the gift money using the electronic money to the server according to the decided amount, and
the second processor is configured to
perform settlement processing of the gift money by the electronic money according to the decided amount, and
output the completion notification including information regarding the invited guest and amount information of the gift money to the organizer terminal.

5. The information processing system according to claim 4, wherein
the invited guest terminal further includes a second display, and
when reading a code printed on an invitation, the first processor is configured to display invitation information to the wedding ceremony on the second display.

6. The information processing system according to claim 5, wherein the first processor is configured to display, on the second display, a screen for requesting input of the amount of the gift money in a case where attendance at the wedding ceremony is selected according to the invitation information.

7. The information processing system according to claim 4, wherein the third processor is configured to display, on the first display, the information regarding the invited guest and the amount information of the gift money in response to the completion notification.

8. The information processing system according to claim 4, wherein the second processor is configured to
calculate points corresponding to an amount of gift money for each of the plurality of invited guests, and
impart, in a case where scheduled end time of the wedding ceremony has passed, the points calculated for each of the plurality of invited guests to each invited guest as points usable as electronic money of the electronic wallet.

9. The information processing system according to claim 8, wherein
the second processor is configured to output a return notification indicating that the points have been imparted to the invited guest terminal in a case where the impartment of the points is completed, and
the first processor is configured to enable a settlement request by the electronic wallet according to the points in response to the return notification.

10. A server comprising
a processor comprising hardware, the processor being configured to decide, based on attendance information indicating that a user attends an event requiring a participation fee and a settlement request for the participation fee using electronic money deposited into an electronic wallet, the user as an attendee of the event and perform settlement processing of the participation fee by the electronic money.

11. The server according to claim 10, wherein the processor is configured to output, to an organizer terminal used by an organizer of the event, a completion notification indicating completion of attendance confirmation of the user to the event and payment of the participation fee after the settlement processing is completed.

12. The server according to claim 11, wherein
the attendee is one of a plurality of invited guests invited by an organizer of a wedding ceremony, and
the processor is configured to
perform, according to an amount of gift money decided for each invited guest terminal used by each invited guest, settlement processing of the gift money using the electronic money, and
output the completion notification including information regarding the invited guest and amount information of the gift money to the organizer terminal.

13. The server according to claim 12, wherein the processor is configured to
calculate points corresponding to an amount of gift money for each of the plurality of invited guests, and
impart, in a case where scheduled end time of the wedding ceremony has passed, the points calculated for each of the plurality of invited guests to each invited guest as points usable as electronic money of the electronic wallet.

14. The server according to claim 13, wherein the processor is configured to output a return notification indicating that the points have been imparted to the invited guest terminal in a case where the impartment of the points is completed.

15. The server according to claim 14, wherein the processor is configured to specify information regarding a return gift for which the points are usable and specify points required to exchange for the return gift in a case where there is a use request of points imparted to the invited guest as a return.

16. The server according to claim 15, wherein the processor is configured to subtract the points used to exchange for the return gift from the points imparted to the invited guest when exchanging the points and the return gift.

17. A non-transitory computer-readable recording medium on which an executable program is recorded, the program causing a processor of a computer to execute:
deciding, based on attendance information indicating that a user attends an event requiring a participation fee, and a settlement request for the participation fee using electronic money deposited into an electronic wallet, the user as an attendee of the event and perform settlement processing of the participation fee by the electronic money.

18. The non-transitory computer-readable recording medium according to claim 17, wherein the program causes the processor to execute outputting a completion notification indicating completion of attendance confirmation of the user to the event and payment of the participation fee to an organizer terminal used by an organizer of the event in a case where the settlement processing is completed.

19. The non-transitory computer-readable recording medium according to claim 18, wherein
the attendee is one of a plurality of invited guests invited by an organizer of a wedding ceremony,
the program causes the processor to execute
performing settlement processing of the gift money using the electronic money according to an amount of gift money decided for each invited guest terminal used by each invited guest, and
transmitting the completion notification including information regarding the invited guest and amount information of the gift money to the organizer terminal used by the organizer.

20. The non-transitory computer-readable recording medium according to claim 19, wherein the program causes the processor to execute
calculating points corresponding to an amount of gift money for each of the plurality of invited guests, and
imparting the points calculated for each of the plurality of invited guests to each invited guest as points usable as electronic money of the electronic wallet in a case where scheduled end time of the wedding ceremony has passed.
